(19) United States
(12) Patent Application Publication
(10) Pub. No.: US 2006/0075436 A1
(43) Pub. Date: Apr. 6, 2006

(54) Plug-in television tuner module and method thereof

(76) Inventor: George C. Schedivy, Aquebogue, NY (US)

Correspondence Address: F. CHAU & ASSOCIATES, LLC, 130 WOODBURY ROAD, WOODBURY, NY, 11797, US

(21) Appl. No.: 10/950,277

(22) Filed: Sep. 27, 2004

(51) Int. Cl. H04N 7/18

(52) U.S. Cl. 725/75; 725/77

(57) ABSTRACT

An overhead device for mobile video applications includes a first coupling for receiving an optional television tuner module, wherein the television tuner module is concealed within an installed overhead device, and a second coupling for coupling a media player to the television tuner module, the media player for processing a television signal received from the television tuner module.

### BACKGROUND OF THE INVENTION

1. Field of the Invention

The present invention relates to a television tuner, and more particularly to a plug-in television tuner module for vehicle video systems.

2. Discussion of Related Art

As society becomes more mobile and therefore spends a greater amount of time traveling and away from home, demand rises for electronic appliances and devices outside the home environment. For example, consoles having video cassette players and screens have been mounted on in vehicles, facilitating video entertainment on the road.

Some consoles may include television tuners integrated into the device to capturing television signals, for example, terrestrial signals or satellite based signals. The consoles are sold as an integrated unit.

Therefore, a need exists for a plug-in television tuner module for vehicle video system applications.

### SUMMARY OF THE INVENTION

According to an embodiment of the present disclosure, an overhead device for mobile video applications comprises a first coupling for receiving an optional television tuner module, wherein the television tuner module is concealed within an installed overhead device, and a second coupling for coupling a media player to the television tuner module, the media player for processing a television signal received from the television tuner module.

The television tuner module comprises an antenna for receiving the television signal.

The overhead device comprises a receiver for receiving control signals of a remote control, the control signals for controlling functions of the media player and the television tuner. An indication of the control signals is displayed on a display of the media player.

The first coupling is positioned in a receptacle for securing the television tuner to the overhead device.

The media player is detachable from the overhead device.

According to an embodiment of the present disclosure, a method for distributing overhead devices and television tuner modules comprises stocking an overhead device and separately a television tuner module, receiving a customer request for installation of the overhead device and the television tuner module in a vehicle, installing the television tuner module in the overhead device, and installing the overhead device and television tuner in the vehicle.

The method comprises placing an order for the overhead device and the television tuner to be stocked, wherein a first number of overhead devices are ordered and a second number of television tuners are ordered, wherein the second number may be greater than, equal to, or less than the first number.

The television tuner module is concealed within the overhead device.

Installing the television tuner module in the overhead device further comprises coupling the television tuner module to a receptacle of the overhead device.

According to an embodiment of the present disclosure, an overhead device for mobile video applications comprises a receptacle for receiving an optional television tuner module, wherein the television tuner module is concealed within an installed overhead device, a media player for processing a television signal received from the television tuner module, and a display for displaying the television signal processed by the media player.

The television tuner module comprises an antenna for receiving the television signal.

The overhead device comprises a receiver for receiving remote control signals for the television tuner module.

The remote control signal is one of a radio frequency signal or an infrared signal. The remote control signal is a short-range wireless signal.

### BRIEF DESCRIPTION OF THE DRAWINGS

Preferred embodiments of the present disclosure will be described below in more detail, with reference to the accompanying drawings:

FIG. 1A is an illustration of a front view of an overhead device and video system according to an embodiment of the present disclosure;

FIG. 1B is an illustration of a side view of an overhead device and video system according to an embodiment of the present disclosure;

FIG. 2 is an illustration of a connection between an overhead device and television tuner module according to an embodiment of the present disclosure;

FIG. 3A is an illustration of an overhead device and television tuner module according to an embodiment of the present disclosure;

FIG. 3B is an illustration of a television tuner in a docking station configuration according to an embodiment of the present disclosure;

FIG. 3C is an illustration of a television tuner in an overhead pod configuration according to an embodiment of the present disclosure;

FIG. 4A is an illustration of a television tuner module and receptacle;

FIG. 4B is an illustration of the receptacle of FIG. 4A; and

FIG. 5 is a flow chart of a method according to an embodiment of the present disclosure.

### DETAILED DESCRIPTION OF PREFERRED EMBODIMENTS

According to an embodiment of the present disclosure a plug-in or snap-in television tuner may be optionally installed within an overhead device for mobile video applications, such as in an automobile. The overhead device may be an overhead pod or docking station. The overhead pod comprises an integrated media player, such as a liquid crystal display and digital videodisk player. The docking station is adapted to receive a media player that may be removed from the docking station for use elsewhere or for security reasons.

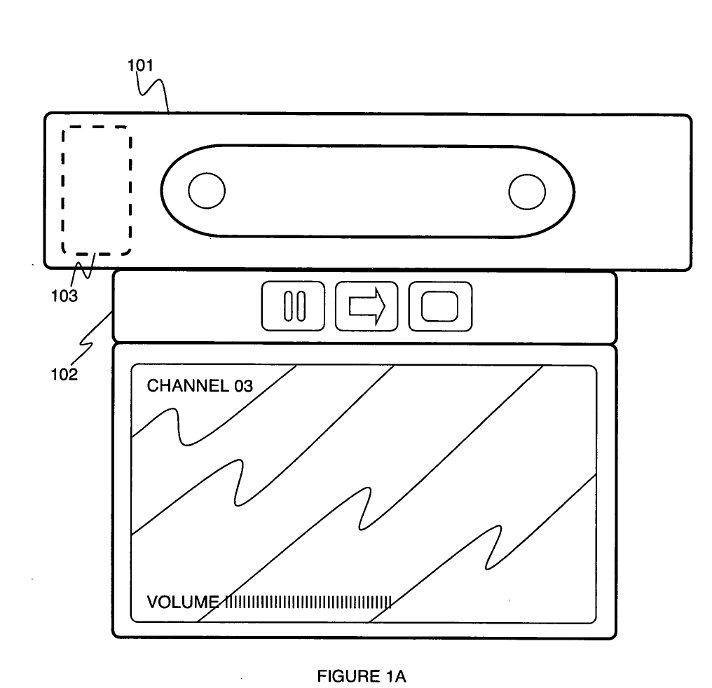

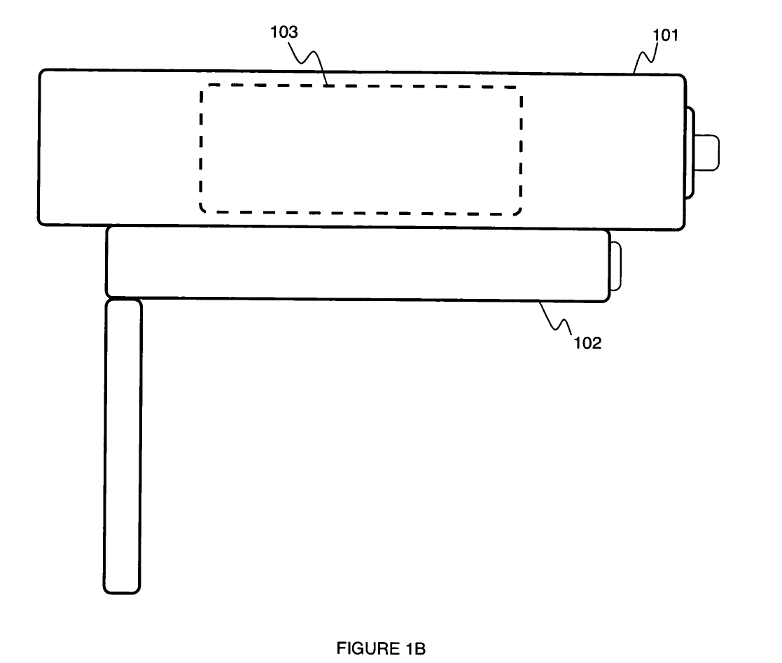

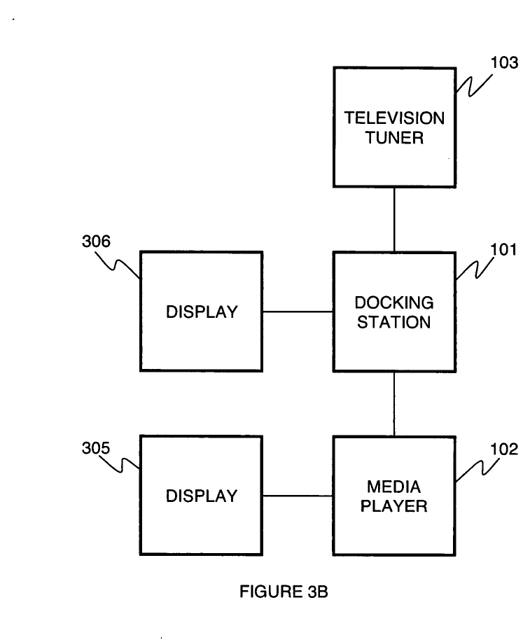

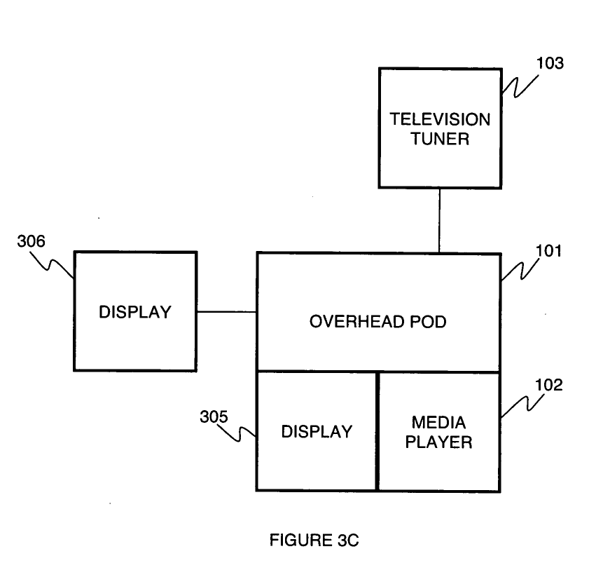

Referring now to FIG. 1, an overhead device 101 includes a media player 102 including a liquid crystal display panel or the like. The overhead device 101 further includes a coupling for receiving a television tuner module 103. The television tuner module 103 may be optionally installed in the overhead device 101 for receiving television signals, for example, from terrestrial transmitters or satellites. The configuration of the plug-in or snap-in television tuner module 103 is applicable to both an overhead pod and a docking station (see FIGS. 3B and 3C).

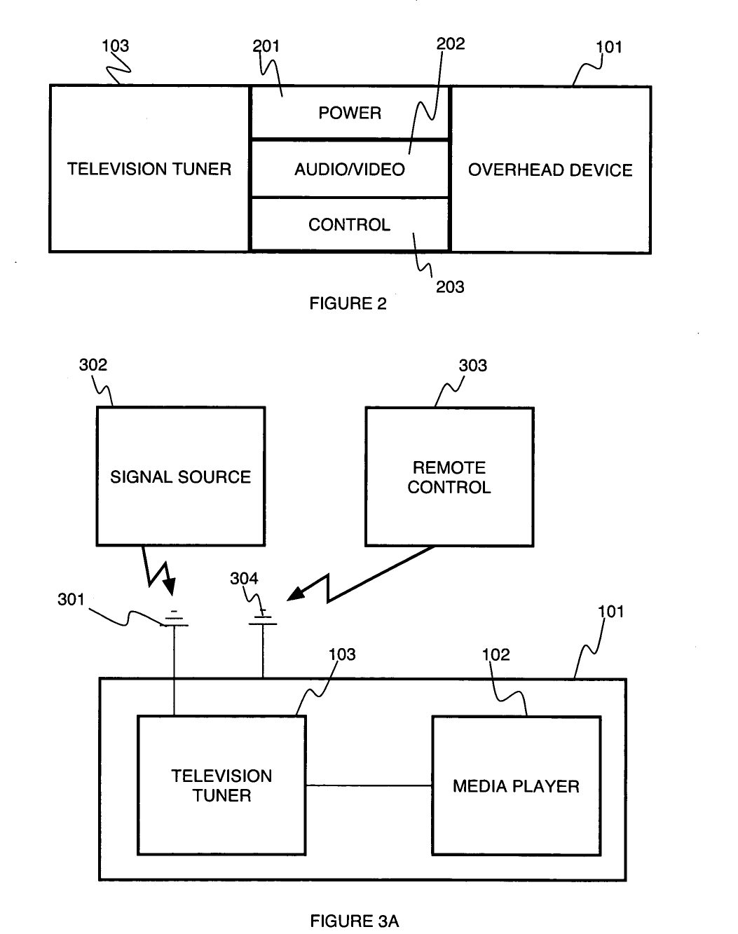

The overhead device 101 comprises a connection port for coupling to the television tuner module 103, for example, a pin array that connects to a corresponding pin array of the television tuner module 103 for providing tuning capabilities to, for example, the video unit 102. Referring to FIG. 2, the connection between the overhead device 101 and television tuner module 103 includes connections for power 201, audio/video signals 202, and control signals 203. The television tuner module 103 is physically connected to the media player 102 through the overhead device 101. The overhead device 101 may further comprise, for example, headphone jacks for playing an audio track from the video unit 102.

The television tuner module 103 may be installed in the overhead device 101 during an installation process. The overhead device 101 may be installed with or without the television tuner module 103, allowing an installer or customer to customize the features of the overhead device 101. The installer stocks the overhead device 101 and television tuners module 103 separately, for example, ordering a 2:1 ratio. Thus, the installer does not need to have available more than one type of overhead device, and may reduce inventory.

Referring to FIG. 3A, the television tuner module 103 comprises at least one antenna 301 for receiving television signals from a signal source 302 such as a ground based antenna or satellite. The antenna may be, for example, a diversity antenna. The television tuner module 103 may also receive remote control signals from a remote control 303 for tuning to different channels. The remote control signals may be received through a receiver/antenna 304 of the overhead device 101. The remote control signals may be, for example, radio frequency signals, infrared signals, wireless signals, e.g., IEEE 802.11 or, short-range wireless signals, e.g., BlueTooth®. Thus, for example, the remote control may be a unit supplied with the overhead device or may be a cellular telephone or personal digital assistant (PDA) having BlueTooth® capabilities.

The video system 102 of the overhead device 101 may be controlled by the remote control 303. Further the remote control 303 includes functionality for controlling the television tuner module 103. Therefore, no additional receiver for a remote control 303 need be installed with the television tuner module 103. Input from the remote control 303 may be displayed on the display screen of the video system (e.g., as an on-screen display), for example, as shown in FIG. 1A.

For docking station applications a pin array of the docking station physically connects to a pin array of the media player 102. As shown in FIG. 3B, the docking station 101 couples the television tuner module 103 to the media player 102. A display 305/306 may be coupled to the media player 102, for example, as shown in FIG. 1A, and/or the docking station 306, for example, a remote display screen mounted in a headrest.

For overhead pod installations, the television tuner module 103 is coupled to the overhead pod 101 comprising an integrated media player 102 and display 305. Further, a remote display 306 may be coupled to the overhead pod 101.

The overhead device 101 can be connected to the vehicle's electrical system and may include additional connections for audio/video signals to external devices, for example, a vehicle's stereo system.

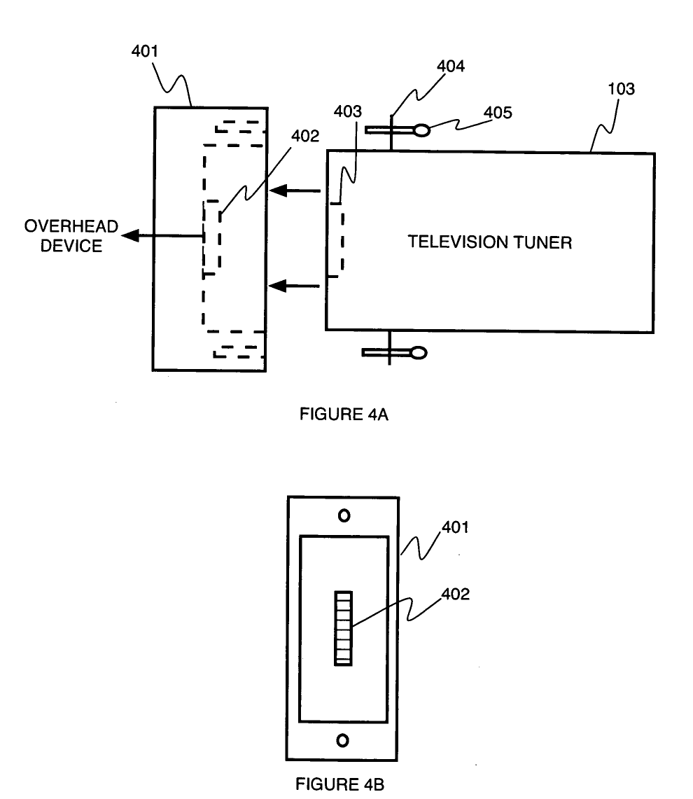

Referring to FIGS. 4A and 4B, the television tuner module 103 is coupled to an overhead pod or docking station via a receptacle 401 of the overhead device. The receptacle 401 includes a means 402 for electrically connecting the television tuner module 103 to the overhead device, including for example, a pin array, an RG59 coaxial cable connection, RCA jacks, an S-video jack, a connection for power (e.g., 12 volt direct current), etc. The television tuner module 103 includes a complementary means 403 for electrically connecting to the receptacle 401. The receptacle 401 may be, for example, a snap, plug, clip, latch, or a combination of these. The receptacle 401 is oriented such that the television tuner module 103 is concealed within the overhead device. The overhead device, including any video display system, remote control, or other mobile audio/video equipment, is coupled to the television tuner module 103 through the receptacle 401. One of ordinary skill in the art would appreciate in view of the present disclosure the various means for coupling the television tuner module 103 to the overhead device may be used, including screws, tape, glue, etc. For example, as shown in FIGS. 4A and 4B, the television tuner module 103 may include tabs 404 having screws 405. The screws 405 may be used for securing the television tuner module 103 to the overhead pod receptacle 401.

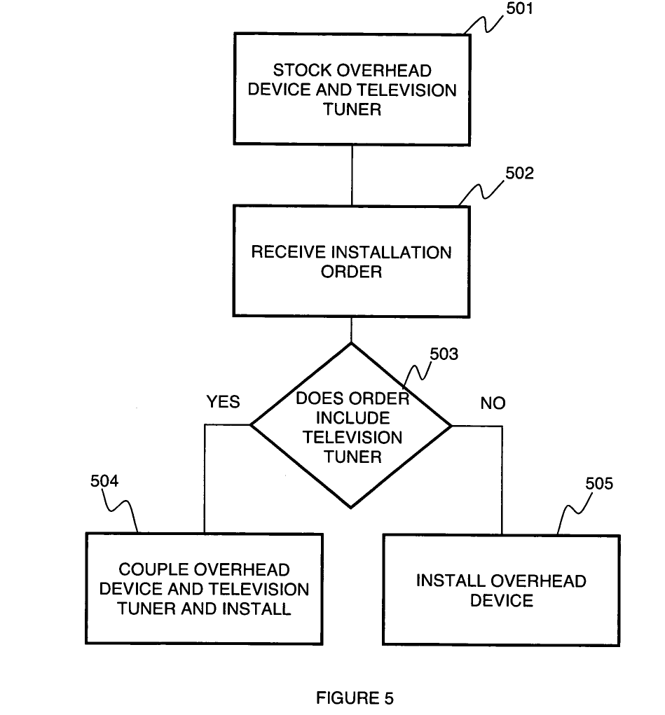

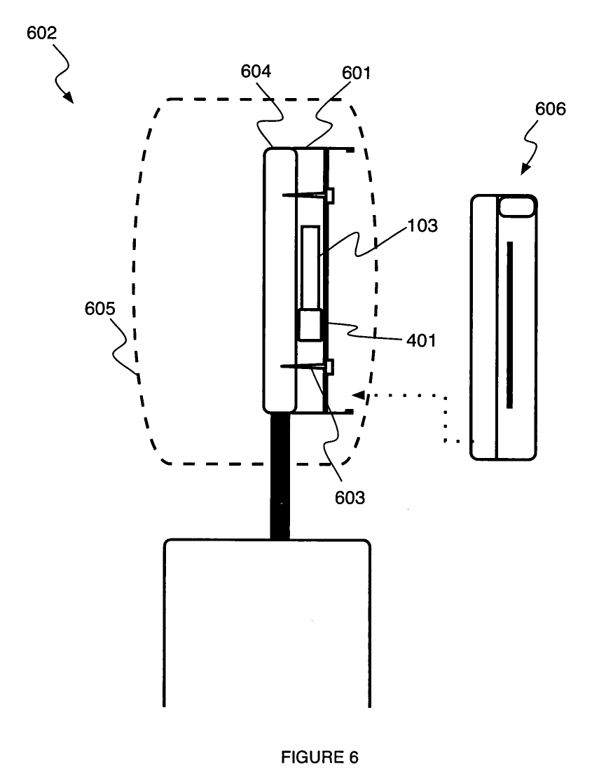

Referring to FIG. 5, an installer will stock overhead pods having a ready connection for television tuners and the television tuners separately 501. Upon receiving an order for installation 502, the installer will determine whether television-tuning capabilities are to be included 503. The installer will connect a television tuner to the overhead pod and install the system 504 for orders requiring television tuners and can install the overhead pod without a television tuner for orders omitting television tuning capabilities 505. Thus, the installer may stock a signal type of overhead pod for both television capable systems and those without television capabilities.

It should be noted, that while embodiments described in the present disclosure include an overhead device, that other devices may be used in conjunction with an internal plug-in television tuner module. For example, devices such as those as described in U.S. application Ser. No. 10/749,443, filed on Dec. 31, 2003, entitled SEAT MOUNTABLE ENTERTAINMENT SYSTEM, incorporated by reference herein in its entirety, may include a receptacle for receiving a plug-in television tuner. The devices may include video players installed in vehicle headrests, seat backs. As shown in FIG. 6 the housing 601 can be fixed to the vehicle seats 602 by, for example, screws 603, catches, adhesives, epoxies and/or any other means known to those skilled in the art. The housing 601 can be secured to an internal support structure 604 of the headrest 605. The housing 601, similar to the overhead device 101, may receive a removable video player 606 or include a video player. The housing 601 includes a receptacle 401 for receiving a plug-in television tuner module 103. Other examples may include portable video players and the like.

Having described embodiments for an overhead device for receiving an optional television tuner, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1-15. (canceled)

16. A vehicle entertainment system comprising:
a docking station comprising a compartment for receiving a television tuner;
a first connection for receiving the television tuner and electrically connecting the television tuner to the vehicle entertainment system, the television tuner for receiving and processing a television signal to output to a display electrically connected to the vehicle entertainment system;
a media player coupled to the docking station; and
a second connection for electrically connecting the media player to the vehicle entertainment system upon coupling the media player to the docking station.

17. The vehicle entertainment system of claim 16, wherein the television tuner comprises an antenna for receiving the television signal.

18. The vehicle entertainment system of claim 16, further comprising a receiver for receiving a control signal of a remote control, the control signal for controlling the media player and/or the television tuner.

19. The vehicle entertainment system of claim 16, wherein an indication of the control signal is displayed on the display.

20. The vehicle entertainment system of claim 16, wherein the first connection includes at least one of a pin array, a coaxial cable connection, a video connection, an audio connection, and a power supply.

21. The vehicle entertainment system of claim 16, wherein the first connection is a receptacle for securing the television tuner to the docking station.

22. The vehicle entertainment system of claim 16, wherein the docking station is an overhead docking station.

23. The vehicle entertainment system of claim 16, wherein the docking station is installed in a back portion of a vehicle seat.

24. The vehicle entertainment system of claim 16, wherein the television tuner is concealed within the compartment.

25. A vehicle entertainment system comprising:
a device comprising a media player and a display for displaying an image;
a compartment within the device for receiving a television tuner; and
a connection for electrically connecting the television tuner to the vehicle entertainment system, the television tuner for receiving and processing a television signal to output to the display.

26. The vehicle entertainment system of claim 25, wherein the television tuner comprises an antenna for receiving the television signal.

27. The vehicle entertainment system of claim 25, further comprising a receiver for receiving a control signal of a remote control, the control signal for controlling the media player and/or the television tuner.

28. The vehicle entertainment system of claim 25, wherein an indication of the control signal is displayed on the display.

29. The vehicle entertainment system of claim 25, wherein the connection includes at least one of a pin array, a coaxial cable connection, a video connection, an audio connection, and a power supply.

30. The vehicle entertainment system of claim 25, wherein the connection is a receptacle for securing the television tuner to the device.

31. The vehicle entertainment system of claim 25, wherein the television tuner is concealed within the compartment.

32. A method for distributing vehicle entertainment devices and television tuners comprising:
stocking a vehicle entertainment device separately from a television tuner;
receiving an order for installation of the vehicle entertainment device including television tuner functions in a vehicle;
installing the television tuner in the vehicle entertainment device; and
installing the vehicle entertainment device including the television tuner in the vehicle.

33. The method of claim 32, further comprising placing an order for the vehicle entertainment device and the television tuner to be stocked, wherein a first number vehicle entertainment device are ordered and a second number of television tuners are ordered, wherein the second number of television tuner and the first number of vehicle entertainment devices ordered are independent of one another.

34. The method of claim 32, further comprising concealing the television tuner within a compartment of the vehicle entertainment device.

35. The method of claim 32, wherein installing the television tuner in the vehicle entertainment device further comprises coupling the television tuner module to a receptacle of the vehicle entertainment device.
